(19) United States
(12) Patent Application Publication
(10) Pub. No.: US 2025/0077580 A1
(43) Pub. Date: Mar. 6, 2025

(54) GRAPH DATA STORAGE

(71) Applicant: Alipay (Hangzhou) Information Technology Co., Ltd., Hangzhou (CN)

(72) Inventor: Da ZHANG, Hangzhou (CN)

(21) Appl. No.: 18/726,941

(22) PCT Filed: May 1, 2023
(86) PCT No.: PCT/CN2023/070606

§ 371 Date: Jul. 5, 2024

(30) Foreign Application Priority Data
Jan. 7, 2022 (CN) 202210014665.2

(51) Int. Cl. G06F 16/901

(52) U.S. Cl. CPC G06F 16/9024

(57) ABSTRACT

This specification relates to storage methods, systems, and apparatuses for graph data. The graph data includes a node and an edge. The storage method includes: storing, in a point table of a data block, node information of several nodes in the graph data, where the node information includes a node identifier; storing edge information of edges of the several nodes in an edge table of the data block, where the edge information includes node identifiers of target nodes connected to the edges; storing attribute information of the several nodes in a point attribute table of the data block; and storing attribute information of the edges of the several nodes in an edge attribute table of the data block.

### TECHNICAL FIELD

One or more embodiments of this specification relate to the computer field, and in particular, to storage methods, systems, and apparatuses for graph data.

### BACKGROUND

Currently, the storage and management of graph data can be implemented by using various databases. With the emergence of new Internet applications such as social networks, mobile Internet, and Internet of Things (IOT), interaction data generated by various entities (for example, users, systems, and sensors) increase exponentially, and the scale and complexity of the graph data increase significantly. When storing and managing massive and complex graph data, the database needs to have relatively high read/write efficiency, to support efficiently performing graph processing operations such as data traversal, association relationship query, and one-hop subgraph (namely, a one-hop graph that is a subgraph including a node and an edge connected to the node) unrolling.

Therefore, storage methods, systems, and apparatuses for graph data are urgently needed, to implement functions such as efficient graph data storage and complex relationship query for graph data.

### SUMMARY

An aspect of this specification provides a storage method for graph data. The graph data includes a node and an edge, and the storage method includes: storing, in a point table of a data block, node information of several nodes in the graph data, where the node information includes a node identifier; storing edge information of edges of the several nodes in an edge table of the data block, where the edge information includes node identifiers of target nodes connected to the edges; storing attribute information of the several nodes in a point attribute table of the data block; and storing attribute information of the edges of the several nodes in an edge attribute table of the data block.

Another aspect of this specification provides a storage system for graph data. The graph data includes a node and an edge, and the storage system includes: a node information storage module, configured to store, in a point table of a data block, node information of several nodes in the graph data, where the node information includes a node identifier; an edge information storage module, configured to store edge information of edges of the several nodes in an edge table of the data block, where the edge information includes node identifiers of target nodes connected to the edges; a node attribute information storage module, configured to store attribute information of the several nodes in a point attribute table of the data block; and an edge attribute information storage module, configured to store attribute information of the edges of the several nodes in an edge attribute table of the data block.

Another aspect of this specification provides an apparatus for graph data storage. The apparatus includes a processor and a memory, the memory is configured to store instructions, and the processor is configured to execute the instructions to implement the apparatus for graph data storage, wherein the apparatus a storage medium and a processor. The storage medium is configured to store computer instructions, and the processor is configured to execute the computer instructions to implement a graph data storage training method.

Another aspect of this specification provides a file for graph data. The graph data includes a node and an edge, the file includes several data blocks, where each data block includes: a point table, configured to store node information of at least some nodes in the graph data, where the node information includes a node identifier; an edge table, configured to store edge information of edges of the nodes, where the edge information includes node identifiers of target nodes connected to the edges; a point attribute table, configured to store attribute information of the nodes; and an edge attribute table, configured to store attribute information of the edges of the nodes.

### BRIEF DESCRIPTION OF DRAWINGS

This specification is further described by means of example embodiments, and these example embodiments are described in detail with reference to the accompanying drawings. These embodiments are not limiting. In these embodiments, the same reference number represents the same structure, where:

FIG. 1 is a schematic diagram illustrating an application scenario of an example storage system for graph data, according to some embodiments of this specification;

FIG. 2 is a schematic diagram illustrating a point table, according to some embodiments of this specification;

FIG. 3 is a schematic diagram illustrating an edge table, according to some embodiments of this specification;

FIG. 4 is a schematic diagram illustrating a point/edge attribute table, according to some embodiments of this specification;

FIG. 5 is a block diagram illustrating a storage system for graph data, according to some embodiments of this specification;

FIG. 6 is a schematic diagram illustrating a data block structure, according to some embodiments of this specification;

FIG. 7 is an example flowchart for storing graph data, according to some embodiments of this specification; and

FIG. 8 is an example flowchart for query graph data, according to some embodiments of this specification.

### DESCRIPTION OF EMBODIMENTS

To describe the technical solutions in embodiments of this specification more clearly, the following briefly describes the accompanying drawings needed for describing the embodiments. Clearly, the accompanying drawings in the following descriptions merely illustrate some examples or embodiments of this specification, and a person of ordinary skill in the art can still apply this specification to other similar scenarios based on these accompanying drawings without creative efforts. Unless clearly learned from the language environment or otherwise stated, the same number in the drawings represent the same structure or operation.

It should be understood that “system”, “apparatus”, “unit”, and/or “module” used in this specification are/is a method used to distinguish between different components, elements, components, parts, or assemblies of different levels. However, if other words can achieve the same purpose, the words can be replaced by other expressions.

As shown in this specification and the claims, unless an exception is explicitly indicated in the context, the words such as “a”, “an”, and/or “the” do not specifically indicate singular numbers and can also include plural numbers. Usually, the terms “include” and “comprise” only indicate steps and elements that are explicitly identified, these steps and elements do not constitute an exclusive list, and the method or the device may further include other steps or elements.

A flowchart is used in this specification to describe operations performed by a system according to the embodiments of this specification. It should be understood that a previous or subsequent operation is not necessarily performed precisely in sequence. Instead, steps can be processed in a reverse sequence or processed simultaneously. In addition, other operations can be added to these processes, or a step or several operations can be removed from these processes.

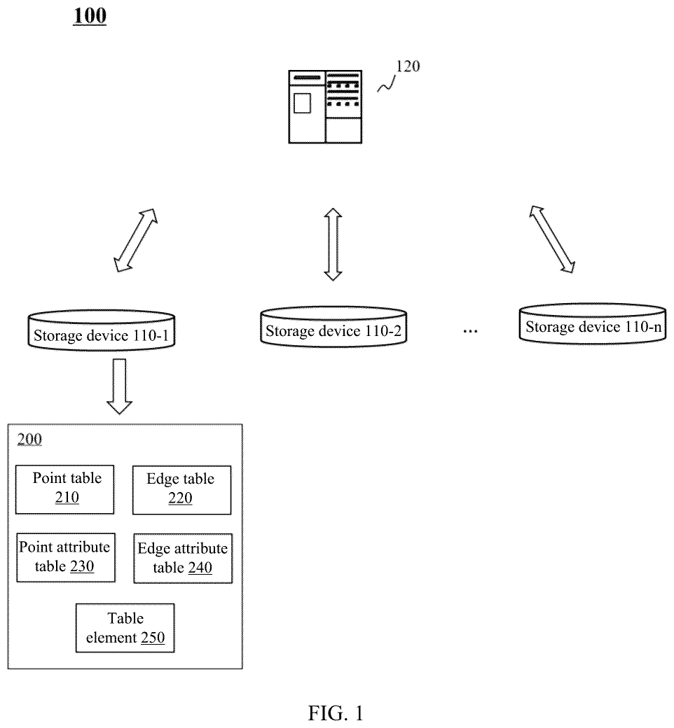

FIG. 1 is a schematic diagram illustrating an application scenario of an example storage system for a graph database, according to some embodiments of this specification.

With the emergence of new Internet applications such as social networks, mobile Internet, and Internet of Things (IOT), data generated between different entities (for example, users, systems, and sensors) increase exponentially, and data internal dependency and complexity increase. A mutual relationship between different entities is usually depicted and represented in the form of graph data. The graph data includes a plurality of nodes and edges connected to the nodes. A node in the graph data represents an entity, and an edge between nodes represents a mutual relationship between entities. The entity can be an object, an institution, etc. that really exists in a physical world; or can be an abstract concept, for example, a company, a device, a person, a product, a storage location, a means of transportation, an image, a computer program, or an account. The entity can have attribute information. For example, the entity is a “person”. The attribute information includes an age, a gender, an occupation, a work unit, a home address, etc. For a company, the attribute information includes information such as a company registration address, a legal person, a business scope, and a registered capital. An edge (i.e., edge information) between entities can reflect a relationship between the entities. For example, an entity person and an entity company can have an employment relationship, and Jack and John can have a friend relationship. The edge can also have attribute information. For example, attribute information of the employment relationship can include an establishment time or an employment relationship type (formal employment or temporary employment).

With the development of Internet technologies, the scale of graph data has become larger. How to store the graph data to efficiently invoke the stored data becomes a problem to be resolved.

In some embodiments, the graph data can be stored in a relational database. In such a storage manner, the node and the edge in the graph data are separately stored. However, the relational database is relatively inadaptive when storing the graph data. For example, because the graph data is large, the graph data need to be stored through sharding. Further, the nodes and the edges of the nodes are stored in partitions. When the graph data are queried, different databases (for example, storage devices) need to interact, to find a target query node and the edge(s) of the target query node, or a target query node and the edge(s) of the target query node can be obtained only when reading/writing is performed for a plurality of times.

To overcome the above-mentioned disadvantages of the relational database, in some embodiments, a manner of storing the graph data based on a graph database is proposed. In the graph database, the relationship between data is important, and the graph database can store massive data with complex relationships and a mutual relationship between complex data. Specifically, in the graph database, the nodes and the edges in the graph data are stored in graph databases of different KV storage engines, and a proxy layer (namely, a proxy layer) is built in the graph database to provide a graph query service. However, in this way, because the proxy layer is added, data need to be cached in different data areas for a plurality of times in a query process, increasing the complexity of the entire query process. On the other side, when a graph query is performed on the graph database, because the nodes and the edges are separately stored, when a one-hop subgraph (namely, a one-hop graph that is a subgraph consisting of a node, the edge(s) connected to the node, and the node(s) connected to the other end of the edge(s)) is retrieved, the node and all edges connected to the node need to be separately queried. In other words, when a one-hop subgraph is queried, a query result of the one-hop subgraph can be obtained only when a read/write operation is performed many times. Consequently, retrieval efficiency is very low. Meanwhile, to ensure efficiency in the above query process, the graph database needs to be deployed and maintained by an independent cluster server (computer), to ensure that there is enough memory to satisfy the requirement to perform the read/write operation for a plurality of times in the graph query process. This also leads to relatively high costs for device operation and maintenance.

To overcome the disadvantage of the above-mentioned technologies, some embodiments of this specification provide a storage method for graph data, including: respectively storing, in a point table, an edge table, a point attribute table, and an edge attribute table of the same data block, node information, edge information, node attribute information, and edge attribute information of several nodes in the graph data. In this manner, node information and edge information of related nodes can be obtained by reading a data block for one time, thereby effectively reducing the read/write frequency in a graph processing process. For example, when a one-hop subgraph needs to be queried, the one-hop subgraph can be queried by reading/writing a data block for only one time, thereby significantly improving query efficiency.

In some embodiments of this specification, a storage order of edges in the edge table can be further consistent with a storage order of the several nodes in the point table, a storage order of attribute information of the several nodes in the point attribute table is consistent with the storage order of the several nodes in the point table, and a storage order of attribute information of edges of the several nodes in the edge attribute table is consistent with a storage order of the edges of the several nodes in the edge table. In this manner, the point table, the edge table, and the attribute table are aligned. After a node A is obtained through a query, locations of all edges corresponding to the node A in the edge table can be quickly determined, and further, attribute information of the node A in the edge attribute table can be quickly located. Due to such a setting, there is not too many data read/write and cache requirements in the graph query process. Therefore, the entire process does not need to be supported by a resident service cluster.

It is worthwhile to note that, in the embodiments of this specification, the graph data are sequentially stored in a plurality of data blocks, and the information of a node and the edge information of the node are stored in the same data block. Graph data with a large scale can be stored in a plurality of data blocks or a plurality of graph files (the graph file includes a plurality of data blocks). Therefore, in one or more embodiments related to this specification, a plurality of devices can store the graph data in a distributed manner and support a parallel query (for example, different devices query different data blocks), to further improve query efficiency.

In some embodiments, an application scenario of the storage system for graph data is shown in FIG. 1. A scenario 100 can include a storage device 110-1, a storage device 110-2, . . . , a storage device 110-n, and a processing device 120.

The storage device 110-1, the storage device 110-2, the storage device 110-3, . . . each can include a processor and a mass memory, a removable memory, a volatile read-write memory, a read-only memory (ROM), or any combination thereof, and are configured to perform data storage, perform resource management, and process data and/or information from at least one component of the system or an external data source (for example, a cloud data center). In some embodiments, each of the storage device 110-1, the storage device 110-2, the storage device 110-3, . . . can be a single server or a server group. The server group can be centralized or distributed (for example, a server 110-1 can be a distributed system), and can be dedicated or can provide a service together with another device or system. In some embodiments, the storage device 110-1, the storage device 110-2, the storage device 110-3, . . . can be regional or remote. In some embodiments, the storage device 110-1, the storage device 110-2, the storage device 110-3, . . . can be implemented on a cloud platform or provided in a virtual manner. By way of example only, the cloud platform can include a private cloud, a public cloud, a hybrid cloud, a community cloud, a distributed cloud, an internal cloud, a multi-layer cloud, etc., or any combination thereof.

In some embodiments, any one or more of the storage device 110-1, the storage device 110-2, . . . , and the storage device 110-n can store one or more graph files, and support a parallel query of the graph data. The graph file can include a plurality of data blocks, and each data block is configured to store node information and edge information of all or some nodes and attribute information corresponding to the nodes and the edges in the graph data. Specifically, as shown in FIG. 1, 200 is a typical data block structure, and each data block includes a point table 210, an edge table 220, a point attribute table 230, an edge attribute table 240, and a table element 250.

The processing device 120 can generate or obtain the graph data, write the graph data into the plurality of data blocks or the plurality of graph files, and distribute the plurality of data blocks or the plurality of graph files to the storage device 110-1, the storage device 110-2, . . . , and the storage device 110-n for storage. In some embodiments, the processing device 120 can obtain a query request, and distribute the query request to the storage devices, so that each storage device queries locally stored graph data or data blocks, and returns a query result to the processing device 120. In some embodiments, when the scale of the graph data is not large, one storage device can be used to store a graph file of the graph data. In this case, the processing device 120 can be omitted.

In some embodiments, the scenario 100 can further include a network (not shown in the figure). The network can connect components of the system and/or connect the system and an external part. The network enables communication between the components of the system and between the system and the external part, facilitating the exchange of data and/or information. In some embodiments, the network 130 can be any one or more of a wired network or a wireless network. For example, the network can include a cable network, an optical fiber network, a telecommunications network, the Internet, a local area network (LAN), a wide area network (WAN), a wireless local area network (WLAN), a metropolitan area network (MAN), a public switched telephone network (PSTN), a Bluetooth network, ZigBee, near field communication (NFC), an in-device bus, an in-device line, a cable connection, or any combination thereof. In some embodiments, a network connection between parts of the system can be in one of the above-mentioned manners, or can be in a plurality of manners. In some embodiments, the network can be various topologies, such as point-to-point, shared, or central topologies, or a combination of a plurality of topologies.

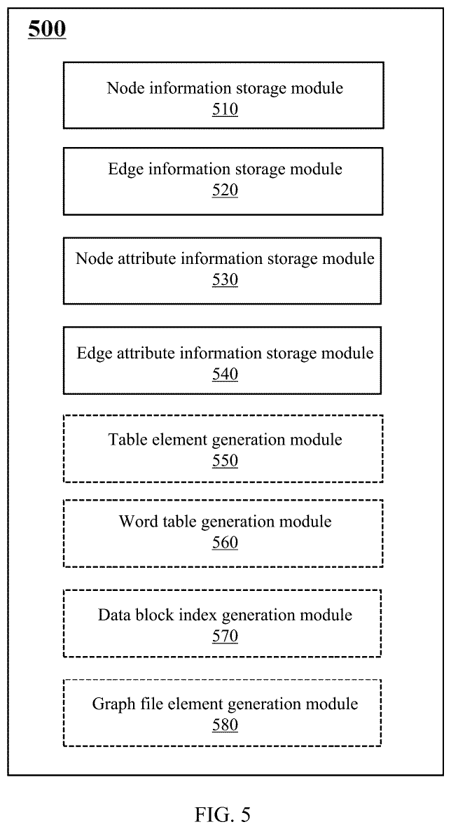

FIG. 5 is a block diagram illustrating a storage system for a graph database, according to some embodiments of this specification.

As shown in FIG. 5, a system 500 is arranged on a processing device (any one of a server 110-1, a storage device 110-2, . . . , and a storage device 110-n shown in FIG. 1) of any executable program, and specifically includes: a node information storage module 510, configured to store, in a point table of a data block, node information of several nodes in the graph data, where the node information includes a node identifier; an edge information storage module 520, configured to store edge information of edges of the several nodes in an edge table of the data block, where the edge information includes node identifiers of target nodes connected to the edges; a node attribute information storage module 530, configured to store attribute information of the several nodes in a point attribute table of the data block; and an edge attribute information storage module 540, configured to store attribute information of the edges of the several nodes in an edge attribute table of the data block.

In some embodiments, a storage order of the edges of the several nodes in the edge table is consistent with a storage order of the several nodes in the point table, a storage order of the attribute information of the several nodes in the point attribute table is consistent with the storage order of the several nodes in the point table, and a storage order of the attribute information of the edges of the several nodes in the edge attribute table is consistent with a storage order of the edges of the several nodes in the edge table.

In some embodiments, the edge table includes an edge table index area and an edge table data area; the edge information of the edges of the several nodes is stored in the edge table data area; the edge table index area stores index information of the edges of the several nodes, and the index information of the edges includes storage address information of the edge information of the edges of the corresponding nodes in the edge table data area; and a storage order of the index information of the edges of the several nodes is consistent with the storage order of the several nodes in the point table.

In some embodiments, the node information further includes storage address information of the edges of the nodes, and the storage address information of the edges in the point table is storage address information of the index information of the corresponding edges in the edge table.

In some embodiments, edge information of different edges of the same node is consecutively stored in the edge table data area, and a storage order of the edge information of the edges of the several nodes is consistent with the storage order of the several nodes in the point table.

In some embodiments, the index information of an edge further includes an edge type, the edge information further includes a node type of a target node, and edge information of edges of the same node is sequentially stored in the edge table data area based on edge types of the edges.

In some embodiments, the edge attribute table includes an edge attribute table index area and an edge attribute table data area; the attribute information of the edges of the several nodes is stored in the edge attribute table data area; the edge attribute table index area stores edge attribute index information of the edges of the several nodes, and the edge attribute index information includes storage address information of the attribute information of the edges in the edge attribute table data area; and a storage order of the edge attribute index information of the edges of the several nodes is consistent with a storage order of the edge information of the edges of the several nodes in the edge table data area.

In some embodiments, the node information further includes node types, and the node information of the several nodes is stored in the point table based on the order of the node identifiers.

In some embodiments, the point attribute table includes a point attribute table index area and a point attribute table data area; the attribute information of the several nodes is stored in the point attribute table data area; the point attribute table index area stores node attribute index information of the several nodes, and the node attribute index information includes storage address information of the attribute information of the nodes in the point attribute table data area; and a storage order of the node attribute index information of the several nodes is consistent with the storage order of the several nodes in the point table.

In some embodiments, the system 500 further includes a table element generation module 550, and the table element generation module 550 is configured to generate a table element of the data block. The table element includes storage address information of each table in the data block and a node identifier of the 1^{st} node in each point table in the data block.

In some embodiments, the data block includes coded information, the system 500 further includes a word table generation module 560, and the word table generation module 560 is configured to generate a word table of a graph file. The word table includes a mapping relationship between coded information in each data block in the graph file and original information.

In some embodiments, the system 500 further includes a data block index generation module 570, and the data block index generation module 570 is configured to generate a data block index for a graph file. The data block index of the graph file includes storage address information of each data block in the graph file and a node identifier of the 1^{st} node in each data block.

In some embodiments, the system 500 further includes a graph file element generation module 580, and the graph file element generation module 580 is configured to generate a graph file element. The graph file element includes a graph file in which each data block is located in all graph files and a sequence number of the data block in the graph file, a node identifier of the 1^{st} node in each graph file, and a node identifier of the last node in each graph file.

In some embodiments, the data block is a minimum read/write unit.

In some embodiments, the edge of the graph data includes an out-edge and an in-edge, the edge table includes an out-edge table and an in-edge table, the edge attribute table includes an out-edge attribute table and an in-edge attribute table, and the node information further includes storage address information of out-edges of the nodes and storage address information of in-edges of the nodes.

It should be understood that the system and the modules of the system shown in FIG. 5 can be implemented in various manners. For example, in some embodiments, the apparatus and the modules of the apparatus can be implemented in hardware, software, or a combination of software and hardware. The hardware part can be implemented by using dedicated logic. The software part can be stored in a memory and executed by a proper instruction execution apparatus, for example, a microprocessor or specially designed hardware. A person skilled in the art can understand that the above-mentioned method and apparatus can be implemented by using computer-executable instructions and/or control code included in the processor. For example, such code is provided on a carrier medium such as a disk, a CD, or a DVD-ROM, a programmable memory such as a read-only memory (firmware), or a data carrier such as an optical or electronic signal carrier. The apparatus and the modules of the apparatus in this specification can be implemented not only by a hardware circuit of an ultra-large-scale integrated circuit or gate array, a semiconductor such as a logic chip or a transistor, or a programmable hardware device such as a field programmable gate array or a programmable logic device, but also by software executed by various types of processors, or can be implemented by a combination (for example, firmware) of the hardware circuit and software.

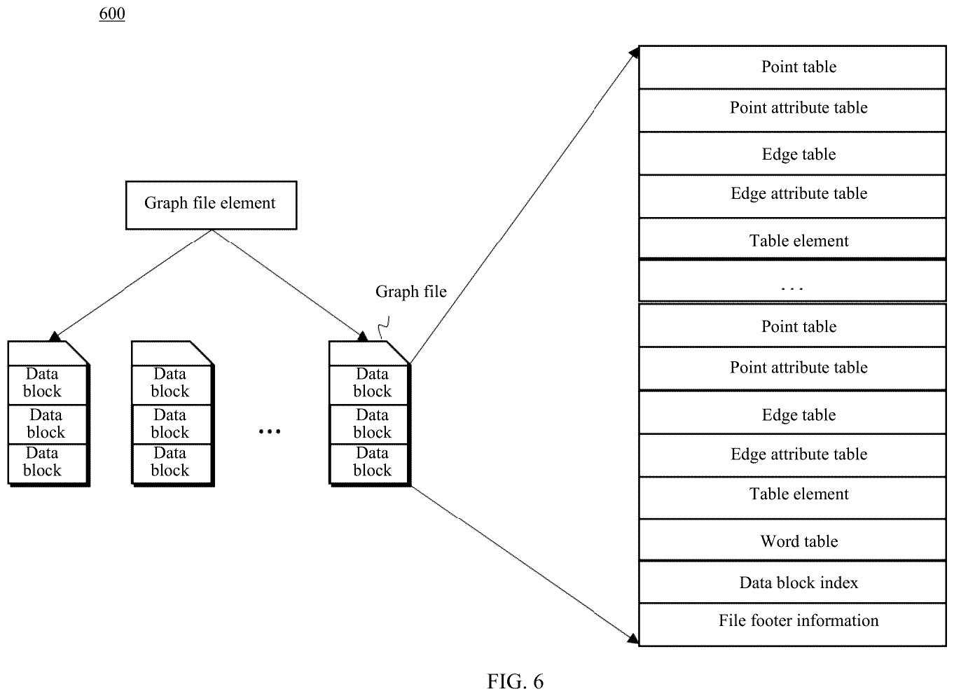

FIG. 6 is a schematic diagram illustrating a data block structure, according to some embodiments of this specification.

The following further describes, with reference to FIG. 6, a form of a storage file in one or more embodiments related to this description.

A storage file 600 includes a graph file element and one or more graph files. The graph file element includes a graph file in which each data block is located in all graph files and a sequence number of the data block in the graph file, a node identifier of the 1^{st} node in each graph file, and a node identifier of the last node in each graph file. A node identifier indicates a number of a node in the graph data, and is used to trace the location of the node in the graph data. For example, the node identifier can be set to a node 1, a node 2, . . . , or a node m. In some embodiments, the nodes in the graph data can be stored in a plurality of data blocks or in a plurality of graph files based on node identifiers, to quickly determine which graph file a target query node is located in. The graph file element can be understood as index information of the plurality of graph files, and can be invoked and accessed by a host computer or a server (for example, invoked in a manner such as an SDK manner).

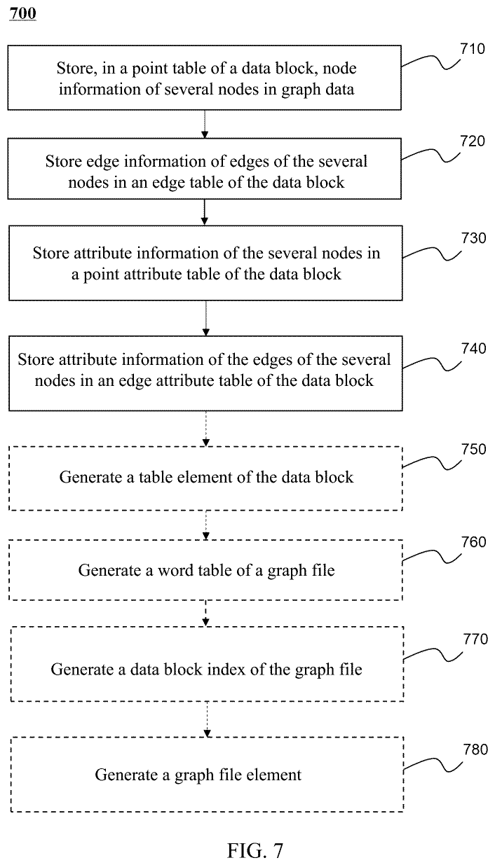

One graph file can include a plurality of data blocks. In some embodiments, the graph file can include a fixed number of data blocks. For example, one graph file can include 1024 data blocks. The data block is a minimum read/write unit, and can be used for storing and writing data. When the graph data are stored, the data block is a minimum write unit; and the processing device can sequentially write the graph data into one or more data blocks based on the format of the data blocks. The data block can have a fixed size, for example, 64 bytes or 128 bytes. When a data block is fully written, a new data block is created to continue writing, until one piece of complete graph data is written. In some embodiments, data in the data block can be from the same graph data or can be from different graph data. The data block specifically includes a point table, a point attribute table, an edge table, and an edge attribute table. In some embodiments, the data block can further include a table element. The table element includes storage address information of each table in the data block and a node identifier of the 1^{st} node in the point table in the data block. The table element can be considered as index information inside the data block, to quickly locate a storage location of each table. For more descriptions about the point table, the point attribute table, the edge table, and the edge attribute table, references can be made to detailed descriptions of a corresponding part in FIG. 7. Details are omitted here for simplicity.

In some embodiments, in addition to including the plurality of data blocks, the graph file can further include file footer information, a data block index, and a word table.

The word table of the graph file is used to record a mapping relationship between coded information and original information. Further, the word table can be used to encode or decode at least a portion of information in the graph file. For example, information such as an edge type and a node type can be represented by a number. For example, a number 1 represents a user-type node, and a number 2 represents a company-type node. Therefore, when the node types are stored in the point table, a corresponding type can be represented by a number such as 1 or 2. A text is represented by a shorter number or letter, to effectively reduce actual storage space of the graph data. Correspondingly, the word table can record a similar mapping relationship such as “1”—the user-type node, and “2”—the company-type node.

The data block index of the graph file includes storage address information of each data block in the graph file and a node identifier of the 1^{st} node in each data block. The data block index of the graph file can be used to quickly determine which data block a target query node is located in.

The file footer information includes a total number of nodes in the data block, a total number of edges, and a file extension area (for example, a file protocol, a compression algorithm, and correction information).

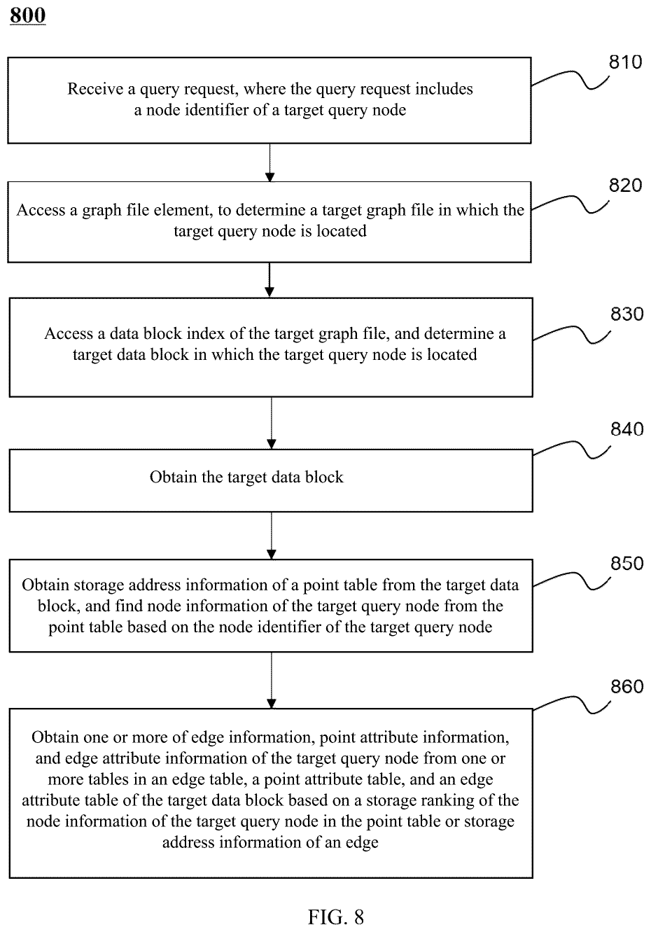

FIG. 8 is an example flowchart for querying graph, according to some embodiments of this specification. With reference to a process 800 shown in FIG. 8, the following describes a use method of a storage file with an example in which a known target query node is used to search for an N-hop subgraph of the target query node. The N-hop subgraph includes edges of N hops of the target query node and a node on each edge. A storage device receives a query request from a service end or a processing device. As shown in step 810, the query request includes a node identifier of the target query node. First, the storage device accesses a graph file element. As shown in step 820, which graph file the target node is stored in is determined based on a node identifier of the 1^{st} node in each graph file stored in the graph file element and a node identifier of the last node in each graph file (for example, a graph file V is targeted). Further, a target data block in which the target query node is located is determined based on a node identifier of the 1^{st} node in each data block stored in a data block index of the graph file (a data block index of the graph file V), as shown in step 830. Then, the target data block in which the target query node is located is located based on storage address information of each data block in the graph file stored in the data block index, as shown in step 840. Specifically, the target data block can be obtained. In the target data block, a point table can be located based on a table element of the target data block, and node information of the target query node is found in the point table based on the node identifier, as shown in step 850. When the node information of the point table is stored in a sequence of the node identifiers, the node information of the target query node can be quickly determined through a binary search. Because the point table, the edge table, the point attribute table, and the edge attribute table are located in the same data block and are aligned with each other, one or more of edge information, point attribute information, and edge attribute information of the target query node can be obtained from one or more tables in the edge table, the point attribute table, and the edge attribute table of the target data block based on a storage order of the node information of the target query node in the point table or storage address information of edges by performing a read operation for one time (for example, loading the data block into memory), as shown in step 860. Further, a one-hop subgraph of the target query node is found. Further, a node identifier of each first-hop neighboring node (a node on a first-hop edge of the target query node) of the target query node in the one-hop subgraph is obtained. The steps are repeated, so that a one-hop subgraph of each first-hop neighboring node can be found, thereby obtaining a two-hop subgraph of the target query node. By analogy, an N-hop subgraph of the target query node is obtained.

It is worthwhile to note that in one or more embodiments related to this specification, the edges of the graph data can include an out-edge and an in-edge. In an embodiment of this scenario, the edge table involved in this specification can be further divided into an out-edge table and an in-edge table, the corresponding edge attribute table also includes an out-edge attribute table and an in-edge attribute table, and the corresponding node information further includes storage address information of an out-edge of the node and storage address information of an in-edge of the node.

FIG. 7 is an example flowchart for storing graph data, according to some embodiments of this specification. In some embodiments, an example process of storing graph data is shown in a process 700. The process 700 can include step 710, step 720, . . . , and step 780. The following describes the process 700 in detail.

Step 710: Store, in a point table of a data block, node information of several nodes in graph data.

In some embodiments, step 710 can be performed by the node information storage module 510. The node information storage module 510 sequentially fills the node information into the point table based on a specified format of the point table. The graph data includes a node and an edge. In some embodiments, the node information storage module 510 can select the several nodes from the graph data for storage. The several nodes can be all nodes in the graph data, or can be some nodes.

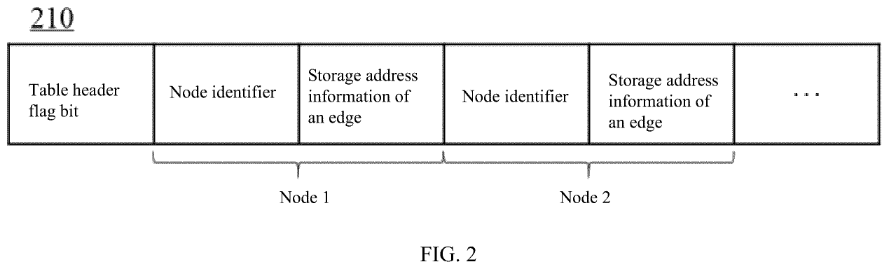

FIG. 2 is a schematic diagram of an example point table 210. The point table stores the node information of several nodes, and the node information includes a node identifier. The node identifier indicates a number of the node in the graph data, and is used to trace a location of the node in the graph data. For example, the node identifier can be set to a node 1, a node 2, . . . , or a node m. In some embodiments, the node information stored in the point table is stored in a sequence of the node identifiers. For example, the node information storage module 510 can select, from the graph data, several nodes whose node identifiers are consecutive, and sequentially store the node information of the nodes in ascending order or descending order of node identifiers.

In some embodiments, the node information further includes storage address information of the corresponding edges of the nodes; and the storage address information of an edge indicates a storage location of the edge in the edge table, for example, can be storage address information of the index information of the edge in the edge table. The storage address information can be an absolute address, or can be an offset relative to a start location. For example, the storage address information of the index information of the edges in the edge table can be an absolute address or an offset relative to a start location of the edge table. With such a setting, during a graph query, after a target node is located, data of an edge connected to the target node can be directly determined based on storage address information of the edge of the target node in the point table.

Usually, a node can include a plurality of edges. In some embodiments, the node information storage module 510 can record storage address information of each edge of the node in the point table. In other words, one piece of node information can record storage address information of all edges connected to the node. However, in some implementation scenarios, because the number of edges corresponding to one node is large (for example, one merchant node can be connected to thousands of user nodes), a large amount of storage resources are occupied when storing storage address information of all edges of the node in the above-mentioned manner. Consequently, efficiency is very low. Therefore, in some embodiments of this specification, edge information of the same node can be consecutively stored in the edge table. For example, the node A has five edges, and a node B has three edges. In the edge table, edge information of the 5 edges of the node A is consecutively stored in one area (for example, an area with a size of 12×5=60 bytes) starting from a first storage location (for example, the 16^{th} byte in the edge table), and edge information of the node B is consecutively stored in another area (for example, an area with a size of 12×3 bytes) starting from a second storage location (for example, the 76^{th} byte in the edge table). Therefore, as shown in FIG. 2, storage address information of an edge of each node stored in the point table can include only a start storage location of the edge of the node in the edge table (for example, storage address information of the edge of the node A is the first storage location, and storage address information of the edge of the node B is the second storage location). In other words, in the point table, an intermediate storage area from storage address information of an edge of a previous node to storage address information of an edge of a current node is considered as storage address information of the edge corresponding to the previous node.

In some embodiments, the edge has a direction, and the node can have an out-edge and/or an in-edge. The in-edge is an edge that points to the node, and the out-edge is an edge that points from the node to another node. Therefore, in some embodiments, in the point table, the storage address information of the edge in the node information can be further divided into storage address information of the in-edge and storage address information of the out-edge. Correspondingly, the edge table can include an in-edge table and an out-edge table. The in-edge table stores only edge information of the in-edge, and the out-edge table stores edge information of the out-edge table. The manner of storing the storage address information of the out-edge/in-edge in the node information and the edge information of the out-edge/in-edge in the out-edge/in-edge table are similar to those in the above-mentioned content. Details are omitted here for simplicity. For more descriptions of the storage address information of the edge, references can be made to the corresponding descriptions in step 720.

In some embodiments, the node information can further include type information of the node. Because the node can describe any entity or object in a physical world, there can be different types of nodes, for example, a node of a user type, a node of a company type, and a node of a location type. A node type (not shown in the figure) can be stored between a node identifier and storage address information of an edge that are of each node shown in FIG. 2. Usually, the node types can be exhaustible. To facilitate the representation and storage of the node types, in some embodiments, the node types can be further encoded inside the graph file based on the word table, and the point table stores only the encoded node type. When the node type of the node needs to be read from the point table, encoding of the node type of the node can be parsed into a node type with clear semantics again, for example, a “user-type node”, based on the word table. By performing encoding/decoding inside a file based on the word table, an expression of the node type can be simplified, to further reduce storage space. For more descriptions of the word table, references can be made to the descriptions in FIG. 6. Details are omitted here for simplicity.

In some embodiments, the node information can be stored based on an order of the node types, and further stored based on an order of the node identifiers. For example, user-type nodes can be stored together, and then, a plurality of user-type nodes are sequentially stored again based on the node identifiers. When ordering is performed based on the node types, the ordering can be performed based on an order of a phonetic alphabet of the first character or an initial letter of the first word of the description text of the node types. The point table 210 shown in FIG. 2 further includes a table header flag bit, and the table header flag bit is used to indicate whether the table has an index area. In some embodiments, the point table does not include an index area, and the table header flag bit of the point table stores “0”.

Step 720: Store edge information of edges of the several nodes in an edge table of the data block.

In some embodiments, step 720 can be performed by an edge information storage module 520. The edge information storage module 520 sequentially fills data into the edge table based on a specified format of the edge table.

In some embodiments, the edge table can include an edge table index area and an edge table data area. It can be understood that, because an edge can be depicted by two target nodes connected to the edge, the edge information can include node identifiers of the target nodes connected to the edge. In some embodiments, the edge information is stored in the edge table data area. For example, the edge table data area stores node identifiers of pairs of target nodes, and node identifiers of each pair of target nodes correspond to one edge. The edge table index area stores index information of edge information of each edge in the edge table, for example, including storage address information of node identifiers of target nodes corresponding to each edge in the edge table data area.

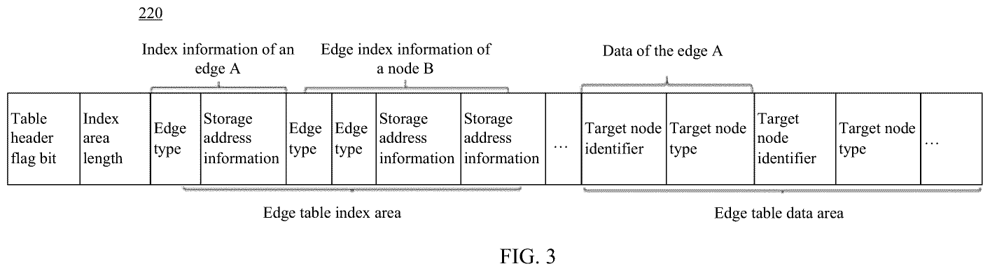

FIG. 3 is a schematic diagram illustrating an example edge table 220. In the figure, the table header flag bit indicates whether the table has an index area. For example, the table header flag bit can be set to “1”, to indicate that there is an index area; and the table header flag bit can be set to “0”, to indicate that there is no index area. Because each edge table includes an index area, the table header flag bit is 1. An index area length represents a total length of the edge table index area, for example, a number of bytes occupied by the edge table index area. The index area length can indicate from which bit the edge table data area starts. The edge table index area is used to store index information of each edge. For example, index information of the edge A points to a location of data of the edge A in the edge table data area. The edge table data area is used to store the edge information of each edge. In some embodiments, the edge information can further include a node type of a target node. In some embodiments, all pieces of edge information have the same storage length. For example, for each edge, four bytes are used to store the node types of the two target nodes, or eight bytes are used to store the node identifiers of the two target nodes.

In some embodiments, a storage order of the index information of the edges is consistent with a storage order of the nodes in the point table (which can also be referred to as alignment between the edge table and the point table). For example, starting from the edge table index area, index information of edges of the 1^{st} node in the point table is consecutively stored, then index information of edges of the 2^{nd} node is stored, and so on. In the edge table data area, for the edge information, the edge information of edges can be sequentially stored in a storage order of the index information of the edges in the edge table index area. Therefore, the index information of the corresponding edge can be found based on a location of the node in the point table. For example, a storage order of a certain node in the point table is determined as k^{th}, and the k^{th} piece of edge index information can be directly read, so that a storage location of a corresponding edge of the k^{th} node in the edge table data area is found based on the k^{th} piece of edge index information.

In some embodiments, a storage order of edge information in the edge table is consistent with a storage order of nodes in the point table, and edge information of the same node is consecutively stored together. For example, the node A is connected to three nodes K, M, and L, the node B is connected to two nodes Q and G, a storage order of the node A in the point table is 1^{st}, and a storage order of the node B in the point table is 2^{nd}. In this case, edge information of the three edges of A-K, A-M, and A-L and edge information of the two edges of B-Q and B-G are sequentially stored from a start location of the edge table data area. In this way, as shown in FIG. 3, the index information of the edges stored in the edge table index area can include only a start storage location of the edge information of the edges of a corresponding node in the edge table (for example, edge index information corresponding to the node A includes storage address information of the edge A-K, and edge index information corresponding to the node B includes storage address information of the edge B-Q). In other words, in the edge table, an intermediate storage area from index information of an edge corresponding to a previous node to index information of an edge corresponding to a current node is considered as edge information of the edge corresponding to the previous node.

Optionally, in some embodiments, the edge table index area further includes an edge type of each edge. As shown in FIG. 3, in addition to the storage address information, the edge index information of the edge A further includes an edge type. The edge type can reflect an interaction relationship between two entities, for example, a litigation relationship between two enterprises or an economic transaction relationship between two enterprises. In some embodiments, when the same node corresponds to a plurality of edges and the plurality of edges belong to different types, in the edge table data area, edge information of the edges of the same node can be stored based on an order of the edge types. In this case, the edge index information corresponding to the node in the edge table index area can include a plurality of edge types and a plurality of pieces of storage address information. The plurality of edge types are consecutively stored, and the plurality of pieces of storage address information are also consecutively stored. As shown in FIG. 3, if the node B has a plurality of edges, and the edges belong to two edge types, the two edge types and two pieces of storage address information can be consecutively stored in the edge index information of the node B. The 1^{st} piece of storage address information is storage address information of edge information that belongs to the 1^{st} edge type in the plurality of edges of the node B in the edge data area (for example, a start storage location of the edge information that belongs to the 1^{st} edge type in the plurality of edges of the node B in the edge data area), and the second storage address information is storage address information of edge information that belongs to the 2^{nd} edge type in the plurality of edges of the node B (for example, a start storage location of the edge information that belongs to the 2^{nd} edge type in the plurality of edges of the node B in the edge data area). With such a setting, when a graph query is performed, all edges that correspond to an edge type corresponding to a node can be quickly located.

In some embodiments, the same as the node type, the edge type is encoded inside the graph file with the word table, and the edge table part stores only internal encoding of the edge types. For more descriptions of the word table, references can be made to the corresponding descriptions in FIG. 6. Details are omitted here for simplicity.

In some embodiments, the edge has a direction, and the node can have an out-edge and/or an in-edge. Correspondingly, the edge table can include an in-edge table and an out-edge table. The in-edge table stores only related data of the in-edge, and the out-edge table stores related data of the out-edge table. The storage manner of the related data of the out-edge/in-edge in the out-edge/in-edge table is similar to that in the above-mentioned content. Details are omitted here for simplicity.

Step 730: Store attribute information of the several nodes in a point attribute table of the data block.

In some embodiments, step 730 can be performed by the node attribute information storage module 530. The node attribute information storage module 530 sequentially fills data into the point attribute table based on a specified format of the point attribute table.

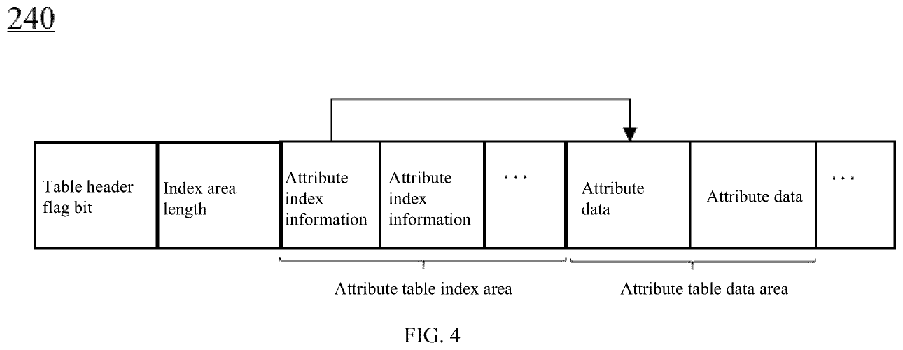

FIG. 4 is a schematic diagram of an example attribute table 240. In some embodiments, the point attribute table and the edge attribute table can have the same format. Therefore, the attribute table 240 can also be considered as a point attribute table. The point attribute table includes a point attribute table index area and a point attribute table data area, where point attribute information is stored in the point attribute table data area. The point attribute table index area stores point attribute index information of a point, where the point attribute index information includes storage address information of the attribute information of the point in the point attribute table data area. As shown in FIG. 4, each piece of attribute index information can point to one piece of attribute data.

In some embodiments, similar to the alignment between the edge table and the point table, the point attribute table can also be aligned with the point table. Specifically, a storage order of the point attribute index information in the point attribute table is consistent with a storage order of the node information in the point table. With such a setting, the point attribute index information can be determined and located based on the storage order of the node in the point table, and the attribute information of the node is further obtained from the point attribute table data area based on the point attribute index information.

In some embodiments, the attribute table 240 can further include a table header flag bit “1” and an index area length.

Step 740: Store attribute information of the edges of the several nodes in an edge attribute table of the data block.

In some embodiments, step 740 can be performed by the edge attribute information storage module 540. The edge attribute information storage module 540 sequentially fills data into the edge attribute table based on a specified format of the edge attribute table.

Similarly, the attribute table 240 can also be considered as the edge attribute table. The attribute information of the edges of the several nodes is stored in the edge attribute table data area. The edge attribute table index area stores attribute index information of an edge, where the edge attribute index information includes storage address information of the attribute information of the edge in the edge attribute table data area.

In some embodiments, a storage order of the edge attribute index information in the edge attribute table index area is consistent with a storage order of the edge information of the edges in the edge table data area.

In some embodiments, the edge has a direction, and the node can have an out-edge and/or an in-edge. Correspondingly, the edge attribute table can include an in-edge attribute table and an out-edge attribute table. The in-edge attribute table stores only attribute information of the in-edge, and the out-edge attribute table stores attribute information of the out-edge. The storage manner of the attribute information of the out-edge/in-edge in the out-edge/in-edge attribute table is similar to that in the above-mentioned content. Details are omitted here for simplicity.

In some embodiments, the process 700 further includes step 750: Generate a table element of the data block. In some embodiments, step 750 can be performed by the table element generation module 550.

The table element includes storage address information of each table in the data block and a node identifier of the 1^{st} node in each point table in the data block. For more descriptions of the table element, references can be made to the corresponding descriptions in FIG. 6. Details are omitted here for simplicity.

So far, one data block is generated. In some embodiments, a plurality of data blocks can be generated in steps 710 to 740, and the plurality of data blocks form a graph file. The graph file can further include information such as a word table and a data block index.

In some embodiments, the process 700 further includes step 760: Generate a word table of the graph file. In some embodiments, step 760 can be performed by the word table generation module 560.

In some embodiments, the data block includes coded information. In this case, the word table of the graph file can also be generated. The word table includes a mapping relationship between coded information in each data block in the graph file and original information. For more descriptions of the word table, references can be made to the corresponding descriptions in FIG. 6. Details are omitted here for simplicity.

In some embodiments, the process 700 further includes step 770: Generate a data block index of the graph file. In some embodiments, step 770 can be performed by the data block index generation module 570.

The data block index of the graph file includes storage address information of each data block in the graph file and a node identifier of the 1^{st} node in each data block, and is used to determine which data block the target query node is located in. For more descriptions of the data block index, references can be made to the corresponding descriptions in FIG. 6. Details are omitted here for simplicity.

So far, one graph file has been generated based on the graph data. In some embodiments, a plurality of graph files can be generated, to form a storage file. The storage file can further include a graph file element.

In some embodiments, the process 700 further includes step 780: Generate a graph file element.

The graph file element includes a graph file in which each data block is located in all graph files and a data block sequence number in the graph file, a node identifier of the 1^{st} node in each graph file, and a node identifier of the last node in each graph file, and is used to determine which graph file the target query node is located in. For more descriptions of the graph file element, references can be made to the corresponding descriptions in FIG. 6. Details are omitted here for simplicity.

Beneficial effects that may be brought by the embodiments of this specification include but are not limited to: (1) Several nodes of graph data, edges of these nodes, and attribute information are stored in a data block. When a graph query is performed, it is convenient to find node-related edges and attribute information in one data block, and there is no need to perform a read/write operation for a plurality of times. (2) The graph data are sequentially stored in a plurality of data blocks. For graph data with a relatively large scale, the graph data can be stored in a plurality of devices in a distributed manner. When a graph query is performed, a plurality of devices can perform a parallel query (for example, different devices query different data blocks), to reduce the retrieval and query time, thereby improving the response speed of the graph query. (3) The point table, the edge table, and the attribute table are aligned, thereby saving storage space of the edge table and the attribute table. It is worthwhile to note that different beneficial effects may be generated in different embodiments. In different embodiments, a beneficial effect that may be generated may be any one of or a combination of several of the above-mentioned beneficial effects, or may be any other beneficial effect that may be obtained.

Basic concepts have been described above. Clearly, for a person skilled in the art, the above-mentioned detailed disclosure is merely an example, but does not constitute a limitation on the specification. Although not explicitly stated here, a person skilled in the art can make various modifications, improvements, and amendments to this specification. Such modifications, improvements, and amendments are proposed in this specification. Therefore, such modifications, improvements, and amendments still fall within the spirit and scope of the example embodiments of this specification.

In addition, specific words are used in this specification to describe the embodiments of this specification. For example, “one embodiment”, “an embodiment”, and/or “some embodiments” mean a feature, structure, or characteristic related to at least one embodiment of this specification. Therefore, it is worthwhile to emphasize and note that “an embodiment”, “one embodiment” or “an alternative embodiment” mentioned twice or more times at different locations in this specification does not necessarily refer to the same embodiment. In addition, some features, structures, or characteristics in one or more embodiments of this specification can be appropriately combined.

In addition, a person skilled in the art can understand that aspects of this specification can be illustrated and described by using several patentable categories or cases, including any new and useful combination of processes, machines, products or substances, or any new and useful improvement thereof. Correspondingly, aspects of this specification can be completely executed by hardware, completely executed by software (including firmware, resident software, microcode, etc.), or can be executed by a combination of hardware and software. The hardware or software can be referred to as “data block”, “module”, “engine”, “unit”, “component”, or “system”. In addition, aspects of this specification can be represented by a computer product located in one or more computer-readable media, and the product includes computer-readable program code.

The computer storage medium can include a propagated data signal that includes computer program code, for example, on a baseband or as part of a carrier. The propagated signal can have a plurality of representation forms, including an electromagnetic form, an optical form, etc., or a proper combination form. The computer storage medium can be any computer-readable medium other than a computer-readable storage medium, and the medium can be connected to an instruction execution system, apparatus, or device to implement a program to be used for communication, propagation, or transmission. Program code located on the computer storage medium can be propagated through any proper medium, including radio, a cable, a fiber optic cable, RF, etc., or any combination thereof.

The computer program code needed for operation of each part of this specification can be written in any one or more programming languages, including object-oriented programming languages such as Java, Scala, Smalltalk, Eiffel, JADE, Emerald, C++, C#, VB.NET, and Python, conventional procedural programming languages such as the C language, Visual Basic, Fortran 2003, Perl, COBOL 2002, PHP, ABAP, and dynamic programming languages such as Python, Ruby, and Groovy, or other programming languages. The program code can completely run on a user computer, or as an independent software package on a user computer, or partially on a user computer and partially on a remote computer, or completely on a remote computer or processing device. In the latter case, the remote computer can be connected to a user computer in any network form, for example, a local area network (LAN) or a wide area network (WAN), or connected to an external computer (for example, through the Internet), or in a cloud computing environment, or used as a service, for example, a software as a service (SaaS).

In addition, unless explicitly stated in the claims, the order of the processing elements and sequences, the use of numbers and letters, or the use of other names described in this specification is not intended to limit the order of the processes and methods described in this specification. Although some currently considered useful embodiments of the disclosure are discussed in various examples in the above-mentioned disclosure, it should be understood that such details are merely used for illustrative purposes. The appended claims are not limited to the disclosed embodiments, and instead, the claims are intended to cover all amendments and equivalent combinations that conform to the essence and scope of the embodiments of this specification. For example, although the system components described above can be implemented by a hardware device, the system components can also be implemented only by a software solution, for example, installing the described system on an existing processing device or mobile device.

Similarly, it is worthwhile to note that, to simplify the description disclosed in this specification and help understand one or more embodiments of this specification, in the above descriptions of the embodiments of this specification, a plurality of features are sometimes incorporated into one embodiment, drawing, or descriptions of the embodiment and the drawing. However, the present disclosure method does not mean that features needed by the object in this specification are more than the features mentioned in the claims. In fact, the features of the embodiments are less than all features of individual embodiments disclosed above.

Numerals describing quantities of components and attributes are used in some embodiments. It should be understood that such numerals used for the description of the embodiments are modified in some examples by modifiers such as “about”, “approximately”, or “generally”. Unless otherwise stated, “about”, “approximately”, or “generally” indicates that a change of ±20% is allowed for the numeral. Correspondingly, in some embodiments, numeric parameters used in this specification and the claims are approximations, and the approximations can change based on features needed by individual embodiments. In some embodiments, the numeric parameters should take into account the specified significant digits and use a general digit retention method. Although in some embodiments of this specification, numeric domains and parameters used to determine the ranges of the embodiments are approximations, in specific implementations, such values are set as precisely as possible in a feasible range.

Each patent, patent application, and patent application publication and other materials such as articles, books, specifications, publications, or documents referred to in this specification are incorporated into this specification here by reference in their entireties, except for the historical application documents inconsistent or conflicting with the content of this specification, and the documents (attached to this specification currently or later) that limit the widest scope of the claims of this specification. It is worthwhile to note that, if the description, definition, and/or use of the terms in the attachments of this specification are inconsistent or conflict with the content of this specification, the description, definition, or use of the terms of this specification shall prevail.

Finally, it should be understood that the embodiments described in this specification are merely used to describe the principles of the embodiments of this specification. Other variations can also fall within the scope of this specification. Therefore, by way of example instead of limitation, alternative configurations of the embodiments of this specification can be considered to be consistent with the teachings of this specification. Correspondingly, the embodiments of this specification are not limited to the embodiments expressly described in this specification.

1. A storage method for graph data, wherein the graph data comprises a node and an edge, and the storage method comprises:
storing, in a point table of a data block, node information of several nodes in the graph data, wherein the node information comprises a node identifier;
storing, in an edge table of the data block, edge information of edges of the several nodes, wherein the edge information comprises node identifiers of target nodes connected to the edges;
storing, in a point attribute table of the data block, attribute information of the several nodes; and
storing in an edge attribute table of the data block, attribute information of the edges of the several nodes.

2. The method according to claim 1, wherein
a storage order of the edges of the several nodes in the edge table is consistent with a storage order of the several nodes in the point table;
a storage order of the attribute information of the several nodes in the point attribute table is consistent with the storage order of the several nodes in the point table; and
a storage order of the attribute information of the edges of the several nodes in the edge attribute table is consistent with the storage order of the edges of the several nodes in the edge table.

3. The method according to claim 1, wherein
the edge table comprises an edge table index area and an edge table data area;
the edge information of the edges of the several nodes is stored in the edge table data area;
the edge table index area stores index information of the edges of the several nodes, and the index information of the edges comprises storage address information of the edge information of the edges of a corresponding node in the edge table data area; and
a storage order of the index information of the edges of the several nodes in the edge table index area is consistent with the storage order of the several nodes in the point table.

4. The method according to claim 3, wherein the node information further comprises storage address information of the edges of the nodes, and the storage address information of a corresponding edge in the point table is storage address information of the index information of the corresponding edges in the edge table.

5. The method according to claim 3, wherein edge information of different edges of the same node is consecutively stored in the edge table data area, and a storage order of the edge information of the edges of the several nodes in the edge table data area is consistent with the storage order of the edges of the several nodes in the point table.

6. The method according to claim 5, wherein the index information of the edges further comprises edge types, the edge information further comprises node types of the target nodes, edge information of edges of the same node is sequentially stored in the edge table data area based on the edge types of the edges, index information of edges corresponding to the same node in the edge table index area comprises one or more edge types and one or more pieces of storage address information corresponding to the edges, the one or more edge types are consecutively stored, and the one or more pieces of storage address information are also consecutively stored.

7. The method according to claim 3, wherein
the edge attribute table comprises an edge attribute table index area and an edge attribute table data area;
the attribute information of the edges of the several nodes is stored in the edge attribute table data area;
the edge attribute table index area stores edge attribute index information of the edges of the several nodes, and the edge attribute index information comprises storage address information of the attribute information of the edges of the corresponding node in the edge attribute table data area; and
a storage order of the edge attribute index information of the edges of the several nodes in the edge attribute table index area is consistent with a storage order of the edge information of the edges of the several nodes in the edge table data area.

8. The method according to claim 1, wherein the node information further comprises node types, and the node information of the several nodes is stored in the point table based on an order of the node types.

9. The method according to claim 1, wherein
the point attribute table comprises a point attribute table index area and a point attribute table data area;
the attribute information of the several nodes is stored in the point attribute table data area;
the point attribute table index area stores node attribute index information of the several nodes, and the node attribute index information comprises storage address information of the attribute information of the nodes in the point attribute table data area; and
a storage order of the node attribute index information of the several nodes in the point attribute table index area is consistent with a storage order of the several nodes in the point table.

10. The method according to claim 1, further comprising:
generating a table element of the data block, wherein the table element comprises storage address information of each table in the data block and a node identifier of the 1^{st} node in the point table in the data block.

11. The method according to claim 10, wherein the data block comprises coded information; and the method further comprises:
generating a word table of a graph file that comprises a plurality of data blocks, wherein the word table comprises a mapping relationship between coded information in each data block in the graph file and original information.

12. The method according to claim 10, further comprising:
generating a data block index of a graph file that comprises a plurality of data blocks, wherein the data block index of the graph file comprises storage address information of each data block in the graph file and a node identifier of the 1^{st} node in each data block.

13. The method according to claim 12, further comprising: generating a graph file element, wherein the graph file element comprises a graph file in which each data block is located in all graph files and a data block sequence number in the graph file, a node identifier of the 1^{st} node in each graph file, and a node identifier of the last node in each graph file.

14. The method according to claim 1, wherein the data block is a minimum read/write unit.

15. The method according to claim 1, wherein the edge of the graph data comprises an out-edge and an in-edge, the edge table comprises an out-edge table and an in-edge table, the edge attribute table comprises an out-edge attribute table and an in-edge attribute table, and the node information further comprises storage address information of out-edges of the nodes and storage address information of in-edges of the nodes.

16. (canceled)

17. A storage apparatus for graph data, comprising a memory and a processor, wherein the memory is configured to store computer instructions that, in response to execution by the processor, cause the processor to:
store, in a point table of a data block, node information of several nodes in the graph data, wherein the node information comprises a node identifier;
store, in an edge table of the data block, edge information of edges of the several nodes, wherein the edge information comprises node identifiers of target nodes connected to the edges;
store, in a point attribute table of the data block, attribute information of the several nodes; and
store in an edge attribute table of the data block, attribute information of the edges of the several nodes.

18. A non-transitory storage device for graph data, wherein the graph data comprises a node and an edge, the storage device stores several data blocks, and each data block comprises:
a point table, configured to store node information of at least a portion of nodes in the graph data, wherein the node information comprises a node identifier;
an edge table, configured to store edge information of edges of the nodes, wherein the edge information comprises node identifiers of target nodes connected to the edges;
a point attribute table, configured to store attribute information of the nodes; and
an edge attribute table, configured to store attribute information of the edges of the nodes.

19. (canceled)

20. The storage apparatus according to claim 17, wherein
a storage order of the edges of the several nodes in the edge table is consistent with a storage order of the several nodes in the point table;
a storage order of the attribute information of the several nodes in the point attribute table is consistent with the storage order of the several nodes in the point table; and
a storage order of the attribute information of the edges of the several nodes in the edge attribute table is consistent with the storage order of the edges of the several nodes in the edge table.

21. The storage apparatus according to claim 17, wherein
the edge table comprises an edge table index area and an edge table data area;
the edge information of the edges of the several nodes is stored in the edge table data area;
the edge table index area stores index information of the edges of the several nodes, and the index information of the edges comprises storage address information of the edge information of the edges of a corresponding node in the edge table data area; and
a storage order of the index information of the edges of the several nodes in the edge table index area is consistent with the storage order of the several nodes in the point table.

22. The storage apparatus according to claim 21, wherein the node information further comprises storage address information of the edges of the nodes, and the storage address information of a corresponding edge in the point table is storage address information of the index information of the corresponding edges in the edge table.
